(19) United States
(12) Patent Application Publication
(10) Pub. No.: US 2014/0278986 A1
(43) Pub. Date: Sep. 18, 2014

(54) TAGGING AND RANKING CONTENT

(71) Applicant: ClipFile Corporation, Newton Center, MA (US)

(72) Inventors: Rolly Rouse, Newton Center, MA (US); Shawn C. Becker, Waltham, MA (US)

(73) Assignee: ClipFile Corporation, Newton Center, MA (US)

(21) Appl. No.: 14/205,741

(22) Filed: Mar. 12, 2014

Related U.S. Application Data
(60) Provisional application No. 61/785,896, filed on Mar. 14, 2013.

(51) Int. Cl. G06Q 30/02; G06F 17/30

(52) U.S. Cl. CPC G06Q 30/0256; G06F 17/3053; G06F 17/30321
USPC 705/14.54

(57) ABSTRACT

Among other things, information is received that represents tags and tag relationships associated by users of content with items of content, and rankings of items of content are derived based on the tags and tag relationships.

This application relates to U.S. provisional patent application Ser. 61/649,031, filed May 18, 2012, and to United States non-provisional patent application Ser. No. 13/896,097, filed May 16, 2013, and is entitled to the benefit of the filing date of U.S. provisional patent application Ser. 61/785,896, filed Mar. 14, 2013, all of which are incorporated here by reference in their entirety.

### BACKGROUND

Due to a rapid expansion in the size of information databases and the volume of digital content available online through Web sites and mobile applications, large numbers of users are now actively employing databases, portals, search engines, social networks, advertising systems, mobile apps, social clipping services, interest graphs, and other information systems and sources of content to help them cope with and sift through an otherwise overwhelming number of content choices.

Users also interact with advertising systems that present advertising content within databases, portals, search engines, social networks, mobile apps, and other sources of content, (including within other advertising systems). These advertising systems, which are designed to monetize user attention, often attempt to filter down and target the advertising content an individual user receives in hopes of increasing the likelihood that a user will purchase goods and services from advertisers.

Currently, a popular search engine may conceivably index 100 trillion pages of content (up from 1 billion in 2000) and may execute more than 100 billion searches per month. Currently, a popular social network has more than a billion users and accumulates roughly 3 billion “likes” per day.

To be effective, information systems such as databases, portals, search engines, social networks, mobile apps, and advertising services—along with social clipping services, interest graphs, and other presentations of and filters for content—must help users find or retrieve desired items of content quickly and effectively. However, in practice the effectiveness of these information services often leaves room for improvement.

What is often neglected in current databases, portals, search engines, social networks, mobile apps, advertising systems, and other approaches to the organization and presentation of content is that not all users are created equal. Information needs vary widely. Not all users share the same interests and wants. Yet, the approaches current information services employ to personalize user experiences and content (including advertising) are often relatively superficial. If the organization and presentation of content is not tuned to match personal preferences, users may have difficultly navigating choices efficiently and finding what they need or want.

Furthermore, whether personalized or not, access to elements of content is often insufficiently contextual, granular, and precise. A lack of context, granularity, and precision may amplify the difficulty users have navigating choices efficiently and finding what they need or want.

For example, with search engines, users must know what they want well enough to type it into the search engine as a search query. But in describing desired content, many users say, “I'll know it when I see it.” This means they don't know what to type in. Further, search engines often link out to results. When they do, the user must typically leave the search engine to see a complete item of content (often a Web page or screen of content in a mobile app). If the user finds content she likes on any of the Web pages—or other elements of content she visits—the search engine is not accessible to her. She cannot use that element of content as a stepping stone to other desired content options, for example, by saying, “Show me more content like this.” Or by saying, “I hate this, so please don't show me things like this anymore.”

In using a search engine, after consuming a Web page or other content the search engine has led her to visit, a user must typically use her back button, or other tools, to return to the search engine search result.

To see more results, she must refine her search query by typing in (or by inputting verbally) her modifications to it, or by creating a new query. To do this, she must know how to revise her search query text (often iteratively) in ways that help her converge on a satisfactory set of search results. How to do this successfully is not always obvious to users. In many cases, devising search query refinements that produce satisfactory search engine search results is simply impossible, even for experts.

FIG. 1 illustrates the extraordinary inefficiency of out and back. A user types in a search query 1 and gets back a list of search results (or a grid, or another presentation). The user selects a search result 2 and clicks on it. She is transported to a web page 3 that is not connected (except by the back button) to the search engine experience. The user scrolls down the web page 4 and finds somewhat interesting results below the fold. Although she does not find what she wants, the element of content she finds below the fold on the web page 5 is instructive to her in some way. But she has no index available to her of the attributes of this element of content 6 such that she may use whatever she sees in it to refine her search.
Current process: a) type in search query, b) select Search result one and go to Web page one, c) scroll down Web page one and find content that's not quite right, but suggests something useful. You're stuck. You can't use what's useful about this content to find other content, but must d) return to the search engine and choose another search result, or refine your search query.
While search engines may be fast and efficient within their frame of reference—which is spidering pages, indexing pages, and serving up pages algorithmically in response to queries, they are not necessarily fast or efficient if viewed in terms of efficiency for the user in converging on the content she wants. This is especially a problem if users say, “I'll know it when I see it” (which applies to many kinds of information, not simply information that is visual).

At times, finding desired search results presents no difficulty. It is not unusual for search engines to give us exactly what we want with just a single query, especially for queries with factual answers. For this we should be deeply grateful. It is an enormous strength, and we couldn't live without out it.

Indeed, when we feel success with a search engine (or any similar process of information discovery) our attention seems to be amplified. Let's say that this amplification is just 10 percent for a helpful result of index. A good outcome not only recharges our attention, it expands it. Just as failure drains our attention, success enlivens it.

In many instances, however, going back and forth (out and back) repeatedly between the search engine and recommended content is inefficient. It's as if, in a library, a user must walk from the card catalog to the stacks, and each time she doesn't find what she wants, she must walk back to the card catalog. And then back to the stacks.

While this is faster and easier when the action is clicking on search results (or refining a search query), it is nevertheless quite inefficient. If the attenuation of attention for this user based on failure to find what she wants is 25 percent, (rates has high as 50 percent have been reported), then 10 out-and-back steps might theoretically drop attention by 94 percent (to six percent).

Social networks face similar challenges with the effectiveness of the user experience. Some critics claim that this is by design, and that the business model for social networks is to waste users' time and to serve up ads to them in this context. One does not have to be so cynical, however, to see that—along with their greatest strength, which is connecting people—social networks have weaknesses.

With social networks, what you see is largely based on what your friends, and friends of your friends, choose to do using the social network. Put differently, with social networks, your “friends” are—at least in part—the editors of the content you see. This is akin to how search engines crowdsource their own editorial process, for example by relying in part on external links added by webmasters to judge the value and calculate the rank of Web pages.

By using friends as editors, social networks create a narrower, friendlier view of “content,” improving the contextual utility of information and offering users a viable technique for addressing information overload, for example, by limiting what a user sees to items posted or otherwise recommended by her friends.

Social networks also offer links to or snippets from outside content (articles, images, and videos, for example). This information notwithstanding, social network content is especially about the feelings, statuses, activities, wants, gripes, opinions, commentary (political and otherwise), and personal photographs of individual users. This makes social network content substantially different from search results, in many cases.

Recent research shows that many social network users actively choose what aspect or aspects of themselves to present in their social network posts. As a consequence, the things a social network user sees are not always an accurate reflection of their friends' authentic preferences.

Moreover, even when social self-expression as communicated through a social network is 100 percent authentic—even when it represents with considerable context, granularity, and precision the real-world preferences and mindsets of each of a user's friends—this may still not be enough to create a satisfying user experience in all cases.

One fundamental problem is that, when you strip things down, we don't always like the same things as our friends do. This is true even of our closest friends. It is even more characteristic for the “tangential” friends whose names gradually creep into our social networks, and who we're too embarrassed to kick out (“unfriend”).

If a user's goal is to keep in touch, for example by seeing what friends are up to, social networks are great.

But we all have work to complete and things to do. Productivity matters, and not just to employers. Productivity, on average, drives not just the wealth of nations, but also the wealth of individuals.

Most of us need and want to be entertained, including by our friends. But we also need to “sharpen the saw.” To learn and grow. To expand our horizons. To tap into our talents. To express ourselves (more than just socially). To pursue opportunities and passions. To conduct research (whether for work or joy). To collaborate successfully on projects of all kinds. To engage with the world. To be effective.

Time and attention are the new scarce resources.

Today, we must all become life-long students (if we are not already). Much of the time, we must engage with content in this context. To learn things. Record our progress. Do work. Achieve results. And communicate or collaborate selectively with people, especially those with whom we've chosen to engage more deeply than is possible with social networks.

In such contexts, a social network experience may not always be as productive or effective as one would like. An aggregation of friends'—and even your own—social preferences may not a terribly good tuning fork for your own less social needs (work, learning, collaboration, etc.). There's often too little signal and too much noise.

In short, general purpose social networks focus primarily on helping people connect with their friends. That's a lot to be good at.

But social networks may offer users “results” (social information) that include a large proportion of unwanted or unneeded stuff, especially in the context of learning, collaboration, and work.

Further, as with search engines, if a user picks a social network result that's partially helpful and then seeks to use that result as a stepping stone or tool to find something similar or different (more like this or less like that), the social network is often of limited use.

That is, in those cases in which the user must leave a social network to consume the content a social network has recommended (read an article, consider a product, etc.), she must often go out and back. But there is no index on these pages that sustains a user's focused inquiry. She can't keep moving forward, and—as with search engines—must go out and back. That is, she must leave the content she has found and return to the social network. This can be tiresome and inefficient.

Thus, search engines and social networks have similar problems. They are, in many circumstances, less helpful to—and less convenient for—users than users would like. Even the best search engines and social networks often present to users a large number of results that users perceive to be extraneous, irrelevant, or just plain unhelpful. And an out and back process that some users may find burdensome.

Advertising systems have similar problems with extraneous, irrelevant, or just plain unhelpful content.

That is, like search engines and social networks, advertising systems have an effectiveness problem. This is true whether advertising is placed or presented adjacent to—or as part of—portal content, or search engine content, or social network content, or mobile application content, or other Web or mobile content.

For example, banner ads are often clicked on only one out of 1,000 times they are viewed, which suggests a major problem with effectiveness.

Further, when one considers the out and back problem, which is an enormous—if largely unrecognized—source of friction, inefficiency, and inconvenience for users, the ineffectiveness of banner ads, from a user's perspective, is truly stunning.

In the case of search ads, the advertising is often better targeted than banner ads (and other display ads), but the out and back (leave and return) process for engaging with content is similar. To refine your search for useful products or services, you must return to the search results page (the page with the advertising). You may not use content on a page you visit when you leave the search engine as a stepping stone to other content. This places a heavy burden on the user. It is inefficient and wastes time. It can be the source of considerable frustration. The user's process of discovery, exploration, consideration, and tuning (in pursuit of desired content—in this case, advertising content for products and services) is dampened.

Like search engines and social networks, advertising systems—in their current form—leave enormous room for improvement.

Search engines and social networks and ad systems and other information systems are, of course, working to improve the quality of choices they offer users. Some recent improvements include coupling a popular search engine to a social network owned by the search engine, adding “social graph” search functionality to a popular social network, and creating “native” advertising units presented in a format and position that directly or partially mimics content (“native ads”).

Social information helps search engines personalize search results. Adding search functionality lets social networks offer faster access to the specific content a specific user seeks. Native advertising formats make ads seem less intrusive and easier to digest.

What you see at a social network is also based what you “like,” that is, elements of content you choose to associate yourself with publicly by clicking a “like” or “plus” button or other interface element in a social network (or in a portal, a search engine, an advertising system, or any other system for organizing and presenting content).

(Note that “likes” or “pluses” are often public or semi-public, so a user may feel uncomfortable using them in some circumstances.)

Other improvements include social networks that offer “real time” information, “visual” social networks, and many others. Real time social networks provide information this is prioritized based on how recently it was posted, and they often present this content in an efficient short format. Visual social networks make it easy for users to share preferred images (a specialized kind of content) and other content, often in the form of “pins” and “pinboards.” Each of these kinds of specialized social network opportunities has attracted successful new market entrants. Other “specialized” or “vertical” social network models have emerged, as well, and when new techniques are successful, general purpose search engines and social networks often choose to adopt similar approaches, as least in part.

As search engines and social networks get to know users, they may choose to personalize the user experiences they offer based on inspection of information gathered directly through user input. Examples include a user's gender, birth date, high school, college, relationship status, hometown, employer, and other such data. Such voluntary user inputs help search engines and social networks target information more successfully to individual users. This may be true not only for their content, but also for their advertising systems and for other advertising systems with which they cooperate.

However, even with the combined input from all of these techniques for learning more about each user (friends' preferences, personal “likes,” and specific voluntary user inputs), a search engine or social network's or advertising system's organization and presentation of content is far from ideal. Many users continue to complain that they feel overwhelmed, and that much of the social content they see is a waste of time.

With today's search engines, social networks, and advertising systems (as well as with many other information systems), users suffer simultaneously from too much information and from too little traction and efficiency in ever reaching the content they desire. Many give up long before they get what they need.

If effectiveness is the measure of success, personalization is not yet satisfactorily personal.

Another technique that search engines, social networks, advertising systems, and other digital information systems use to improve the quality of “results” offered to users is to track a user's inferred preferences by placing a cookies or cookies in her browser, or by using other “tracking” techniques. In doing so, they may record pages viewed, links clicked, and other online activities.

Information systems may use this data that they collect about user online activities to “behaviorally target” content, advertising, or both, even though users are often unaware that they are being tracked. Information systems may also track user activity on pages that are not part of the search engine or social network or advertising system itself.

Sometimes this is helpful and improves results. Other times it is counterproductive. At best, many users and regulators feel that such behaviorally based tracking and targeting is creepy, especially when the process of tracking is not fully transparent, which is generally the case. At worst, many users and regulators consider such tracking and targeting to be a serious violation of personal privacy.

What is troubling is that it seems to be nearly impossible to craft satisfactory solutions to these problems with the targeting of ads through regulation or transparency alone. Similar user privacy and regulatory problems apply to the targeting of content.

Statistically based “anonymous” tracking techniques are a cornerstone requirement for current approaches to targeting. They are integral to most targeting technology, and regulators—who simultaneously permit and limit invasions of personal privacy—require it. That is, they permit snooping, but place loose or strict limitations on how the snooping is done, how long data may be kept, and how the privacy of personal data and user identities will be protected. Given that these limitations are increasingly fragile or ineffective, the risk to the “targeting industry” of a destructive train wreck—or competitive disruption, or both—is growing.

In many cases, each search engine, social network, or advertising system exists and operates separate and apart from the rest. Where genuine integration exists, it is often integration between the search systems, social systems, advertising systems, database systems, and other information systems owned by a single company. And because that company may compete with other search engines, or social networks, or advertising systems, or other systems, it may seek block integration of personalization (and other useful services) to avoid helping its competitors. From the user's perspective, such competitive silos are often counterproductive.

Well-intended regulations often reinforce these competitive impulses to create silos. Market and government imperatives currently in place seem destined to prevent the creation of integrated user experiences of personalized content.

Furthermore, within each Balkanized system for addressing a portion of each user's life and activities there is a persistent problem with incorrect framing. That is, the frame is incomplete and is designed to fit within the regulatory limitations that are rightly placed on snooping, privacy, and the protection of personal data.

In most cases, it is simply not possible for a search engine, social network, or ad system to use current approaches to user tracking (search activities, content choices, likes, what friends like, and anonymous snooping, among others) to discover what a specific user at a specific moment is seeking to accomplish (even in general, let alone in particular). Systematic, user-friendly, privacy-protected customization and personalization of content across companies and brands and sites and apps is impossible.

Another problem for the organization of content comes with the well-know idea of simple tag matching.

In the case of databases for which simple tags are adopted throughout and the quality of attribution is consistent and the quantity of tags is evenly adopted, tag matching can create outstanding signals to be used in the organization, ordering, and presentation of content, including in search engines, social networks, ad systems, to name but a few of many potential applications.

Unfortunately, simple tags are typically not adopted throughout databases of content, or if they are, the structure and meaning of the tagging varies considerably. Even within a single database, the quality of tag attribution is anything but consistent across databases. The number of tags associated with any item of content varies widely.

Different database users may use different words to describe the same element of content or they may use the exact same words, but mean something else. (This is true even if a company seeks to enforce uniformity of data language usage on its employees and contractors.)

Moreover, as tags are added, different database users may have widely divergent opinions about the value and meaning of an element of content (in addition to choosing different words to say essentially the same thing). They may hate an author but like the point he's making. They may love an author but hate the point she's making. They may think—in a general sense—that an article is idiotic, but may say that a selected highlight within it is brilliant.

Individual opinions vary over time and are contextual to other factors (the weather, their mood, the job they are working on, and many more).

### SUMMARY

In general, in an aspect, information is received representing tags and tag relationships associated by users of content with items of content, and rankings of items of content are derived based on the tags and tag relationships.

Implementations may include one or more combinations of any two or more of the following features. The rankings are based on counts of the tags or the tag relationships or both. The counts are weighted. Each of at least some of the tags represents an observation by a user with respect to at least one of the items of content. At least some of the tags represent observations on the observations, recursively. The rankings are derived based on importance of tags. The rankings are derived based on associations of tags. The importance of tags is inferred based on counts of tags or normalized counts of tags. The associations of tags are inferred based on relationships or normalized relationships of tags. The rankings are derived by evaluating scores for the tags. The scores are weighted based on the positions of tags in lists and clusters of tags. The scores are weighted based on weighting information provided by users and by weights assigned to users. The rankings are determined in part based on context. The rankings are expressed as ordered lists of tags. The rank of a tag is based on a sum of an importance score of a tag and an association score of a tag. The rankings of tags span a particular set of content items, users, sources, authors, or topics, or a combination of any two or more of them. The rankings of tags are calculated. The calculation includes determining how in tune content is. Ranks of tags are used to identify patterns, clusters, or networks of related tags. Personal preferences of users are displayed in context based on the tag rankings. Preferences of groups of users are displayed in context based on the tag rankings. The context includes at least one of the following: user preferences, user choices, user activities, locations, sources, authors, topics, media types, time periods, and any combination of two or more of those. Tags and rankings of tags are displayed to a user in context. The ranking of tags is based on calculating contextual tag importance scores and contextual tag association scores. The contextual tag association scores represent how related two tags are in a specific context or across multiple contexts. The tag rankings are used in creating, organizing, or distributing items of content to users. Dynamic indexes of tags are formed for users. The tag indexes derived from the tag rankings are programmable.

In general, in an aspect, items of content are ranked based on information about tags provided by users of the items of content. The items are ranked contextually. The contextual utility of items of content are determined mathematically based on analysis of tags that have been provided from multiple sources. The analysis includes identifying matches or partial matches of tags relative to items of content. The multiple sources include curators of items of content, large numbers of public users, or inferred tags about items of content. The ranking has a scope. The scope includes tags of a given user, tags of all users, or tags of a defined group of users. The scope includes a period of time. The scope includes source, author, topic, or media type or any combination of two or more of them. The scope includes preferences. The preferences are associated with authors, topics, mindsets, or any combination of two or more of them. Variable controls are provided to users that enable continuous adjustment of a presentation of tags associated with the rankings of tags. The variable controls adjust the presentation of tags along one or more of the following ranges: general to personal, broad to specific, individual to group, one context to another context, one source to another source, one author to another author, one period of time to another period of time, and any combination of two or more of them. The rankings of tags span a range of opinions. The tags are analyzed as a combined cyclic and acyclic graph having a potentially infinite number of nodes each of which represents a tag, and tags are connected based on a feature of their relationship. The tags that are ranked span a network of items of content. Pairs of tags and directional associations between the tags are tracked. At least some of the pairs of tags have a hierarchical relationship to one another. The ranking of tags is based on counting of tags based on importance and their associations. The tag counting includes a weighting based on the directional associations. In general, in an aspect, evaluating associations among items of content is done using observations and observations on observations provided by one or more users of the items of content, and in a specific context. The evaluated associations are used in ranking the items of content. The associations are evaluated based on observations provided by a group of users. The evaluating is based on observations by a single user with respect to multiple items of content. The evaluating of the associations is based on a context. The evaluating of the associations is with respect to any item or items of content.

In general, in an aspect, the associations among observations of users about items of content are used to build dynamic indexes of the items of content. The dynamic indexes of content match the preferences of an individual user. The dynamic indexes of content match the preferences of an individual user, and in a context. The dynamic indexes are also built using measures of importance of the observations.

In general, in an aspect, ranks of observations of users about items of content are used to build dynamic indexes of the items of content. In general, in an aspect, ranks of observations of users about items of content are used to build dynamic indexes of the items of content that match preferences of one or more users. The dynamic indexes match the preferences in a context.

In general, in an aspect, ranks of observations of users about items of content are used to enable items of content from multiple users to flow together organically. The items of content flow together organically and in a context. The users include authors, or sources, or combinations of them.

In general, in an aspect, ranks of observations of users about items of content are used to enable personalization of items of content from one or more sources. The personalization is in a context.

In general, in an aspect, a syndication of items of content from one or more sources to one or more other sources is enabled based on rankings of observations of users about items of content. The syndication is in a context.

In general, in an aspect, ranks of observations of users about items of content are used to build continuously adjustable user interface controls that enable dynamic views of content, including dynamically personalized views of content. The building of the interface controls is in a context.

In general, in an aspect, importance scores for observations of users about items of content are calculated. The calculation is in a context.

In general, in an aspect, association scores for observations of users about items of content are calculated. The calculation is in a context.

In general, in an aspect, ranks of observations of users about items of content are used to match items of content with other items of content. The matching is in a context. The matching is based on at least one of: similarity of content, complementarity of content, or dissimilarity of content, or combinations of any two or more of them.

In general, in an aspect, users of items of content are matched with other users of items of content based on patterns of observations of the users about the items of content or associations among the observations or both. The matching is in a context.

Aspects of the present invention provide systems and methods for ranking and indexing content in any publically available or private database using tags, tag importance (tag counts), and tag relationships (tag association scores), to compute tag ranks contextual to any circumstance or element of content.

One aspect provides a mathematical ranking of the contextual utility of content (in general and to a specific user) based on exact matches or partial matches across editorially curated, crowdsourced, and algorithmically-inferred tags on the elements of content under consideration.

The scope of the tag rank (or tag importance or tag association score or contextual tag rank) may be defined in any number of ways. It may be defined based on tags added by this user, or by all users, or by any group of users a) today, b) this week, c) over the past month, d) over the past year, e) for all time, f) during a specified time period (custom), or any other. It may be defined based on tags and tag ranks specific to any source, author, topic, or media type, or any combination of these and other filters.

For any user or combination of users, the scope of the content rank may also be limited to a) content from preferred sources, b) content from preferred authors, c) content about preferred topics, d) content matching preferred tag patterns (mindsets), and many other preference vectors, and these may also be further filtered by time period or media type, or based on any tag or combination of tags or pattern of tags, or based on any other context.

Tag ranks and tag rank-based indexes of content may be presented using sliders that dynamically adjust the tags or tag clusters or mindsets the user sees (for example, from general to personal or from broad to specific, to name just a couple).

One aspect of the invention is to associate tags with content and tags with tags.

One aspect of the invention is to rank content across various opinions and viewpoints. That is, to treat tags and content as variably and contextually worthwhile, rather than as facts associated with facts.

One aspect is to permit a wide range of observations—and observations on observations ad infinitum. In the host system, a tag is not a simple tag, but rather is an index entry (or cluster or network or mindset) for any element of content. Hence the host system is designed to allow observations on anything and in any desired dimension. Observations include (on a scale or as a simple either-or choice) love vs hate, agree vs disagree, and many others.

One aspect is that the invention applies to databases large and small. In theory, it can be applied to all digital information across the world wide web and mobile devices and private databases, which is to say all the world's digital information. It can also be applied as a digital index of physical content, including location-based content such as public libraries, private libraries, college and other school libraries, retail showrooms, trade-only showrooms, buildings, streets, topographies, historical sites, travel destinations, and more.

Another aspect is to provide publishers with tools to incorporate tag rank services—including tag rank driven indexes—into their own content.

Another aspect is to offer publishers ways to build content networks and networks of networks across a wide variety of content sources, and to make possible the flow of information (and revenues) through these networks using tag ranks.

One aspect is to permit customization of content and of indexes for navigating content options (including tag options and related tags) for web sites and mobile apps and other uses of content.

Another aspect is to permit personalization of content and of tag indexes for navigating content options at web sites and mobile apps and other applications of content.

One aspect is to offer tools for syndicating and monetizing content

Additional aspects will become clear from the following description.

### DESCRIPTION

### List of Figures

FIG. 1—The extraordinary inefficiency of out and back

FIG. 2—An idealized sustained search and discovery process with dynamic indexing of content wherever a user goes

FIG. 3—The problem with flat tag data structures

FIG. 4—The problem with hierarchical data structures

FIG. 5—Creating a more organically networked structure of tag relationships

FIG. 6—A simple implementation of a more organic structure of tag relationships

FIG. 7 A more complex example of a more organic tag structure

FIG. 8—A two-tier (flat) mark-up that builds organic tag relationships

FIG. 9—Counting tag association scores (simple counting rule)

FIG. 10—Counting tag association score points—example with three tags

FIG. 11—Counting tag association scores (simple counting rule)

FIG. 12—Tag association and tag importance scores

FIG. 13—Tag rank algorithm factors, partial list

FIG. 14—A view of tag options and related tags, each of which is based on tag rank calculations (tag importance scores and tag association scores)

FIG. 15—View two levels of related tags, first for “online advertising” (which is related in this case to the tag “online advertising” in “tag options”) and second for “native advertising” (which is related to “native advertising”)

FIG. 16—View “tag details” for “banner ads,” including an ordered list of “related tags” (tags related to banner ads), speeding tagging (just touch or click the plus sign).

FIG. 17—Scroll down to see additional related tags for “banner ads”

FIG. 18—Use tags (in this case recent tags related to Apple) to search for content. In this case, the search is for content that matches “competitive advantage,” “Apple,” and “the future of television.”

FIG. 19—View search results that match “competitive advantage,” “Apple,” and “the future of television.”

FIG. 20—View content highlights for the selected search result

FIG. 21—View an index of the content highlights for the selected search result (based in this case on the user's tags on these highlights)

FIG. 22—Collapse the view of the highlights down to see only those highlights that match the index element (tag), “the TV experience needs to be reinvented, too.”

FIG. 23—View just the highlights that match “the TV experience needs to be reinvented, too.”

FIG. 24—View a content index using a grid (could do full screen instead) for a user's own clippings

FIG. 25—View of the same content using a 12-grid (which is a kind of index), or another sized grid

FIG. 26—View content as a list (which is a kind of index)

FIG. 27—View the user's highlights for a selected article

FIG. 28—See a full-screen view of the same article highlights (or potentially in other instances the text of the full article, with or without images, if the publisher permits it)

FIG. 29—See a full-screen index of the same article highlights (or potentially an author, or publisher, or other view of any index of this article and its highlights)

FIG. 30—Select preferred tags (e.g. using checkboxes) and see a collapsed version of the content showing just those highlights that match the preferred content, or search for other content using the selected tags

FIG. 31—View just the highlights that match the selected tags—in this case, “shift to mobile advertising” and “mobile banners are awful” FIG. 32—Go to an “item view” of the same article to see the original Web page (or other source content) in its unadulterated current form

FIG. 33—Jump to a full-screen view of the content in its unadulterated current form, complete with advertising, with “bookmarklet functionality” at the top and bottom

FIG. 34—A user may gain easy access to his tags on this article, as well as to “related tags” for adding “tag details” without needing to leave this full screen Web view

FIG. 35—A spiral view of related tags suggests potential integration of tag ranks and tag rank services with voice commands or hand gestures.

FIG. 36—Flow chart for tagging, tag associations, personalization, and personalized content indexes

FIG. 37—Ways host, or publishers, or others may use host service to personalize views of their own content, including using sliders that make personalization a variable

FIG. 38—Other potential uses of tag rank

FIG. 39—Tag patterns (mindsets) and resonant tuning

### DETAILED DESCRIPTION

This invention involves methods for associating content with other content, especially by building on a user's observations regarding elements of content (and her observations regarding her observations, ad infinitum). More particularly, it relates to methods for calculating contextual tag importance scores (by counting frequency of tag usage, for example) and for calculating contextual tag association scores (also called relatedness scores), which illustrate how related two tags may be, both in a specific context and across any number of contexts.

Tag importance scores and tag association scores are both kinds of tag rank. Put differently, tag ranks involve a) counting tags, that is, the frequency of tag matches, and b) counting tag associations, that is relationships between tags. Tag ranks are contextual, granular, and precise in ways not generally possible with current information systems and techniques.

Tag ranks are useful for allowing content from multiple sources to flow together and for organizing, customizing, and personalizing the content users engage with at Web sites and mobile applications and at other information services they use, including using dynamic indexes that help users find what they want more easily and effectively. Each tag rank-based index is programmable. That is, tag ranks, indexes, lists, and tag-rank-computed factors may be combined with control logic to program new indexes, and combinations of indexes, each of which is programmable.

Specifically, a method assigns ranks to and among elements of content. Ranks are based on counts of tags and tag relationships, weighted counts of tags and tag relationships, and patterns of tags and tag relationships.

Tags represent observations—and observations on observations, ad infinitum—regarding elements of content. Elements of content include tags, comments, highlights, whole items of content such as articles, books, videos, audio files, or datasets, and collections and other defined clusters of content.

Because the method involves ranking content based on tags, it is called tag rank (other names may be used). Tag rank reflects a combination of factors, which may be divided into two parts. The first of these is tag importance scores. The second is tag association scores.

Tag importance scores (other names may be used) may be calculated, in general or in any specific context, by inspecting counts—or normalized counts of tags. Tag importance scores are weighted counts of tag frequency.

Tag association scores (other names may be used) may be calculated, in general or in any specific context by inspecting the relationships—or normalized relationships—among tags. Tag association scores are weighted counts of tag relationships.

Both tag importance scores and tag association scores may be weighted, among other things, based on a tag's position in a list of tags, and based on the quality weighting assigned to a specific user who added that specific tag in that position in that list.

Together (or separately), tag importance scores and tag association scores may be used to calculate the contextually appropriate ordering of lists of tags and lists of elements of content.

A tag rank equals the sum of any weighted tag importance score and any weighted tag association score. In some circumstances, the applicable tag rank will be primarily or even entirely based on the tag importance score. In other circumstances, the applicable tag rank will be primarily or even entirely based on the tag association score.

Tag ranks may be calculated in a general sense or in any specific context. They may be computed, combined, or tuned across any set of elements of content, across any set of users, sources, authors, and topics, and across any combination of these and more. Tag ranks may be computed by simple addition, or contextual addition, or by using weighted scores and linear and non-linear combinations of weighted scores. Tag ranks may also be computed using Fourier transforms and other techniques to compute how “in tune” or “resonant” or “dissonant” one element of content, or group of elements of content, is with any other element of content or group of elements of content.

Tag ranks may be used to identify tag patterns, clusters, or networks of related tags, which are sometimes also called mindsets, as well as digital patterns of relationship among these mindsets, such as similarity, dissimilarity, or complementarity.

Tag ranks may flow together organically for an individual user and may be used to create contextual views of a user's personal preferences in any context (which are also a kind of mindset). Tag ranks may flow together organically for any group of users (an organization or group of organizations, for example) and may be filtered using any context. Contexts may include almost anything: user preferences, user choices, user activities, locations, sources, authors, topics, media types, time periods, and many other factors.

Tag ranks make possible the calculation and presentation to users of their own mindsets, including any associated tags and patterns of tags and in any context, individually or blended with those of other users. Within any context, tag ranks associated with potential combinations of mindsets may also be calculated and presented.

Tag ranks make possible the creation of numerically driven indexes of content, each of which reflects—at root—the nuanced views of individual human observers. This approach, which might be called a people-powered library and index, permits the organization, presentation, and syndication of content—including advertising content—in ways that are not possible with current techniques for organizing information.

The method is particularly useful in addressing the problem of low signal-to-noise ratios and information overload. It promises to increase the value of content to users by allowing hosts, aggregators, publishers, editors, curators (including libraries, museums, galleries, and others), content creators, individual users, and others (including groups of the above in any combination) to organize, contextualize, customize, and personalize content more effectively, while protecting user privacy, and to do so anywhere across the Web and mobile applications and across other content experiences, including at physical locations.

An individual user need not add any tags at all for the host system to work well. She may simply trade on, and benefit from, tags added by others. The more others use the system, the better it will work for her, even if she has added no tags. However, the more she uses the host system and adds her own tags, the better it will personalize her experience of content.

A database of recursive observations, and observations on observations (ad infinitum) about content can be expressed as a combined cyclic and acyclic graph with a potentially infinite number of nodes. In this graph, anything can be a tag. And any tag can have contextual, granular, precise relationship with any other tag. Or it may have a relationship that's more distant and ambiguous, or that is inferred by the system.

One powerful aspect of our system is that anything can be a “tag,” any tag can be associated with any other tag, and any tag relationship can have an unlimited number of tags that define it (in general, at a point in time, or in any context or combination of contexts).

This simple structure, in which everything is a kind of tag, makes it possible to build things of almost infinite complexity, but without increasing the complexity of the host data model, which remains simple. Everything is a tag. Any tag can be associated (related) with any other tag. Any tag relationship—that is, the relationship between two tags—may be associated with any number of related tags. And each of these related tags may be associated with any number of related tags. Ad infinitum.

(In the current implementation of the present invention, the tags attached to tag pairs and intended to capture aspects of the contextual relationship between two tags (sometimes called relationship tags) are most often used for system observations, such as date/time stamps or for privacy settings. They may, however, be used for many other things. They may capture and record and apply and count any information that is contextually related to a particular tag pair.)

This structure of tags makes possible context, meaning, depth, customization, and personalization of content of a sort not currently practical using standard flat tagging systems or hierarchical database systems, or even—in many cases—no-SQL database systems or Big Data approaches.

In our invention, content is neither a flat list, nor a tree, nor an unstructured but statistically or otherwise guess-based indexed blob. Although the structure is in many respects anti-hierarchical, it permits users to clearly define the equivalent of hierarchical structures if they wish to do so. And information can be very highly structured, but within a flexible, organic framework.

The host system makes possible and supports operation of a potentially infinite number of content networks, and networks of such networks. Across these networks, and networks of networks, every tag, highlight, whole item, or collection of items of content (collectively elements of content) can be connected—directly or indirectly—to every other element of content (however distantly), at least in theory if not always in practice.

This structure of tags makes possible an acceleration of learning and collaboration within and across Web sites, mobile apps, and other content. It is far superior to Big Data approaches to capturing and using information. Big Data is often gathered by snooping on users (that is, collecting data about activities and preferences in a non-transparent manner). Big Data frequently involves considerable statistical guesswork. Big Data is, as a consequence, often less-well structured and less-accurately curated than user-generated, organically structured observations, and observations on observations (tags, and tags on tags).

With the host system's structure of information based on tag ranks (including tag importance scores and tag association scores in any combination), except for system inputs and inferences, data input is performed and controlled by each individual user based on that user's purposes and intent. In this sense, the system is neither driven by snooping, nor by algorithms (although algorithms certainly play an important role in helping users by counting, tuning, and amplifying tags and tag relationships, to name a few).

Compared to an idealized search process, as illustrated in FIG. 2, the current process (FIG. 1) may increase the time and effort the user must expend to find desired results. In some cases, it may be such an impediment that the user will simply give up without finding what she wants.

Conversely, in an ideal search process (which is like finding what you want with a single query), three satisfying forward steps (with a theoretical 10 percent attention increase each) might cancel out one energy-sapping (25 percent) step backward. If such a ratio could be preserved, a user might be willing to continue searching (or discovering) indefinitely. The key to this may be to offer users access to universal content indexes wherever they go.

This is—on the surface—similar to Amazon selling books and other goods, but letting others sell them as well. Amazon doesn't do this altruistically (although it does create a better user experience that builds trust and loyalty). Amazon's commissions on sales by outside merchants through its system now reportedly account for more than half of Amazon's profits.

An idealized search and discover process FIG. 2 might go a step further, making a universal index available to each user essentially everywhere. This might sustain a user's attention better than current search and discovery services. The focus would be on saving the user time and improving her ability to find the content she wants and needs.
Idealized process: a) type in search query, or while visiting a Web page or app, see something you like (sort of), somewhere, anywhere, and b) use dynamic indexes of content from within a Web or app page (or via a bookmarklet or other method) to keep moving forward. Go back only when you want to, not because you're forced to.

FIG. 3 illustrates the problems with flat tags. It presents a list of 13 flat tags related to mobile phones.

With flat tags, also called simple tags, there is little or no structure. This avoids many problems associated with hierarchical data structures, but it creates a solution in which the structure of information is often too sparse to build interoperable networks of tag associations and contextual tag associations.

Tags, and simple patterns of tags, may be associated with an element of content, which is helpful. And it is easy to count tag matches, for example when searching content.

But while the importance of a tag can be inferred, for example based on its placement in a list or row of flat tags, information that signals the relationship between one tag and the next is missing.

As a consequence, information needed to identify and count tag associations—and to build powerful, customized, personalized indexes of tag relationships—is not available.

One advantage of flat tags is their simplicity. Flat tags don't create silos, and they may be used for simple tag matching. The ranking of the tag match may be based on the total number of tag matches without de-duping, or on the number of tag matches after de-duping, or based on weighted and/or normalized tag matches, or based on a variety of other simple techniques (or combinations of these).

Simple tags (flat tags)
Key benefits
   simplicity
   search using tags
   select tags, or tag combinations, that match
Key problems
   one tag is not explicitly related to another tag.

In the simplest simple tag match, the rank of the match would be

r(A)=n

where n is the number of matching tags.

FIG. 4 illustrates the problems with hierarchical tags. It uses the 13 tags from FIG. 3, but organizes them as categories in a hierarchical tree.

For example, the category phones 7 is a parent and the subcategory mobile phones 8 is a child. The subcategories office phones 9 and home phones 10 are siblings of the subcategory mobile phones 8.

In this example, cell phones is a synonym for mobile phones 8 and feature phones 11 and smartphones 12 are types (children) of mobile phones 8.

Types of smartphones include iPhones 13 and Android phones 14, as well as Apple phones 15, Motorola phones 16, Google phones 17, and Samsung phones 18.

From a limited perspective, this hierarchical structure makes sense.

But no hierarchical structure can work perfectly. Each hierarchical choice requires compromises, some of which almost always create problems later.

This potential hierarchical structure, as shown in FIG. 4 is, at the very least, incomplete. And it is in many respects silly.

For example, in the minds of cord-cutters, Android phones 14 might also be office phones 9 or home phones 10. With Google's acquisition of Motorola Mobility, Motorola phones 16—which were already a kind of Android phone 14—are now a kind of Google phone 17.

One might fix some of these problems by adding even more hierarchical structure. But that wouldn't necessarily fit well with the ways most people think. Adding deeper hierarchical structure often feels arcane, and it may fail to match the words most users—given the choice—would choose when they describe relationships between tags. It wouldn't really solve the underlying problems with the information architecture.

The example shown in FIG. 4 is just one of many potential hierarchical structures for this list of tags. Whatever hierarchy a database uses, it will be wrong for many applications and confusing for others. The bigger the hierarchical categorization scheme, the more these sorts of problems are likely to compound.

Hierarchies may create information structures that are inflexible and that fail over time. A categorization scheme may be out of date in a year or two or five or ten, at which point many categories and items may need to be painstakingly reorganized.

Hierarchy often blocks healthy information flows. It may help create information silos and cul de sacs that impede the organic development and refinement of associations between tags, both in general and specific to any context. Hierarchy often keeps information from efficiently reaching the users most likely to value it. For the Internet, it is frequently the equivalent of blocked arteries.

Furthermore, for most people hierarchy is cryptic and obtuse. It's not how most people think or talk. It's not natural and organic, and Internet databases are best designed for human beings, not for algorithms.

Hierarchal categories
Key benefits
   adds tightly controlled
   structure
Key problems
   structure is nested and
   complex
   not fluid
   not organic
   may not match words that a user selects
   creates information silos

FIG. 5 illustrates a more organic set of tag relationships, building on top of the 13 tags in FIG. 1 (for simple tags) and in FIG. 2 (for hierarchical tags).

In the approach of the present invention to recording and using tags and tag relationships, the information structure is neither flat nor top-down. It emerges much more organically from observations (and observations on observations, ad infinitum) made by individual users.

The point is less about the specific markup, for which there are many options, but that the host system makes it easy for users to add tags in ways that create tag associations, and other similarly organic tag structures, making the counting of contextual tag associations (and the creation of tag rank-based indexes) dramatically easier.

Organic tag structure in which any tag may be related to any other tag
Key benefits
   allows tightly controlled structure AND simplicity
   user can search using tags and combinations of tags
   bridges across users and types and sources of information
   flexibility
   ability to compute tag ranks (tag importance scores plus tag association scores)
Key problems
   none significant

Among other things, the host system records pairs of tags. Tag pairs are directional, but directionality may be tracked or ignored. In this presentation, for simplicity we choose to ignore directionality. That is, in the preceding example, phones point to mobile phones and mobile phones point back to phones. Both associations are counted equally, even though logically the forward direction (phones pointing to mobile phones) might take some precedence over the backward direction (mobile phones pointing back to phones). In the present invention, directionality may be counted as well. But it's easier to understand the relationships and the math if directionality is temporarily set aside.

One kind of tag pair is between a root tag and a subordinate tag, whether the root tag is on an element of content, or on a highlight of an element of content, or on a highlight of a highlight of an element of content, and so on. Another kind of tag pair is between a level one subordinate tag and a level two subordinate tag attached to it, or between a level two subordinate tag and a level three subordinate tag attached to it, and so on.

Subordinate tags are, by definition, related tags. Root tags that have at least one subordinate tag are, by definition, related tags. As a practical matter, all tags end up having many relationships—whether explicit or inferred.

Root tags are also counted (without respect to their tag relationships) to measure tag importance. This is similar to the counting and matching of simple tags.

Subordinate tags may also be included in calculations of tag importance scores, for example by giving level one subordinate tags a weighting that's a fraction of the weight assigned to root tags. And by giving level two subordinate tags a weighting that's a fraction of the weighting assigned to level one subordinate tags. One example would be to assign a one point, a one-half point, and a one-quarter point of weight for tags at each of these three levels. Tag counts for tag importance scores may be de-duped, or not. They may also be normalized to unity for any element of content, or not.

The host system also has tags on the tag relationship. These tags may capture the date and time the tag relationship was created or modified, the user who created the tag relationship, and many other things.

For the sake of simplicity, this presentation sets aside the tags on tag relationships (even though they are an essential part of how the host system works), as they are generally (but not exclusively) system-created tags, not user created tags.

Any user may associate an unlimited number of root tags with any element of content, or with any highlight of any element of content, or with any collection of elements of content (of any type, scope, or dimension).

Any user may also associate any number of subordinate tags with any root tag, typically in the form of an ordered list or row of tags (for which the order may or may not matter). Root tags are also elements of content, as are subordinate tags and tags attached to the relationships between any pair of tags.

Any user may also associate an unlimited number of subordinate tags with any subordinate tag (and an unlimited number of subordinate tags with any of these, ad infinitum). Subordinate tags are also elements of content. Indeed, all tags are elements of content.

There is no limit to the size or type or scope or depth of the tags a user chooses to add. Nor is there any requirement that users add any tags at all to an element of content (for example, when she clips it or shares it).

In a sense, subordinate tags (at any level) are akin to asking and answering questions about the root tag or subordinate tag with which they are paired (and to which they are attached). Questions are often (but not necessarily) posed in the direct context of this element of content. For example, if the root tag is phone, the question in the user's mind might be, “OK, what kind of phone?” Answers might include, iPhone, white iPhone, white iPhone 5, iPhone 5; used iPhone 5, my mobile phone. Whatever descriptions or qualifiers come to the user's mind.

The structure is fluid and organic. A user can keep attaching her observations, in any number or order, and her observations on her observations, in any number until she is finished. Or she can add no observations at all and everything still works fine (albeit without the same level of context, granularity, and precision as would be possible if she invested time and energy into being more clear in her observations about the element of content she is tagging).

A user may also use the host system's tag structure to express opinions, which are also a kind of tag. Opinions or comments may appear as root tags or as subordinate tags. The user may, at her option, identify an opinion or comment as such by placing a tag on it (for example, “my opinion” or “my comment” or using any other tag she chooses). This has the advantage of making it easy for her to later search for these within the elements of content she has tagged.

In short, the host system is designed to minimize the amount of structure a user must master while at the same time giving a user the capacity to build an almost unlimited amount of structured organic interconnections among elements of content, if that's what she wants. The philosophy behind the host system design is that it's best to trust users to make choices for themselves.

Our invention allows users to record their observations in ways that are useful to them for their own purposes. For example, they may use their observations (tags) to recall and retrieve saved content, to understand their own mindsets and what they've been learning, to search for new content using their own observations (tags) as search parameters, to share saved content with others such that observations they've included add value to the content and make communication about it more efficient.

Users don't have to agree with one another. They don't have to use the same language.

The fact that different users make different observations makes possible associations between elements of content and between observations and between observations and elements of content. It makes possible indexes that bridge across differential choices (by individual users) of language for their observations, not to mention wide-ranging expressions of opinion.

FIG. 6 illustrates a simple implementation of a more organic structure of tag relationships. The tags in this case refer to an article in The Wall Street Journal. In this example, there is only one root level tag or observation (philanthropy 19). Attached to it are four subordinate tags or observations (charitable giving 20, Mark Zuckerberg 21, Silicon Valley 22, and tech moguls 23). These four tags amplify or disambiguate or add to the meaning of the root tag. One might say that the article is about charitable giving 20, which means roughly the same thing as philanthropy 19. Or that it's about charitable giving 20 by Mark Zuckerberg 21. Or that it's about philanthropy 19 by tech moguls 23 in Silicon Valley 22. You get the idea.
a root observation/tag 24, in this case of an article in The Wall Street Journal on charitable giving by the top tech mogul philanthropists in Silicon Valley in 2012
subordinate observations/tags 25 on the root observation, in this case on philanthropy, and in the specific context of a Wall Street Journal article on charitable giving by tech mogul philanthropists in Silicon Valley

Although on the surface this structure—with a root tag (tag) and an ordered (or unordered, if one desires) list of subordinate tags (related tags) may look like a rigid hierarchical structure, it is not. The indented tags are not subcategories of a category called philanthropy, but rather an ordered (or unordered) list of associated tags, each of which supports its own list of associated tags. The subordinate tags are observations on the reader's observation that the article is about philanthropy. That is, they are observations made by a specific user in the context of a specific element of content. A different reader might say that the article is about tech mogul philanthropists in Silicon Valley or that it's about using startup wealth for social good.

Note that this is an example of a more organic tag markup with just one root tag. The patent filing referred to at the beginning of the first paragraph of this document describes how users may gain access to pools of tag options based on the tags that other users have added, that is, on how this system for tagging is essentially collaborative (even as user identities are, as a default, kept private).

FIG. 7 presents a more complex example of a more organic tag structure for this same Wall Street Journal article on charitable giving by Silicon Valley tech moguls. Additional tags have been attached to three of four of the level one subordinate tags (Mark Zuckerberg 26, Silicon Valley 27, and tech moguls 28). In some cases tags, additional subordinate tags have been attached to these three tags (including at multiple levels of depth, rather than just one).

In each case, the subordinate tags answer questions about—or otherwise clarify or amplify or contextualize or add to—the tag to which they are attached. Note that this is the general intent, but it is not—however—a firm requirement.

For example, the tag charitable giving 29 that is attached to Mark Zuckerberg 26 clarifies that, in the context of this article, Mark Zuckerberg's philanthropy 30 (the root tag to which Mark Zuckerberg 26 is attached) is also charitable giving 29, and that—in the context of charitable giving 29, Mark Zuckerberg gave $500 million in 2012 31.

One can see immediately that this structure creates much more flexibility and much more potential for users to express nuances about relationships than either simple tags or rigid hierarchical data structures.

The tag charitable giving by Silicon Valley tech moguls in 2012 32 clarifies the meaning of philanthropy 30 in Silicon Valley 27, and specifically in the context of this article.

Mark Zuckerberg tops the list 33 is a tag that amplifies one aspect of charitable giving by Silicon Valley tech moguls in 2012 32 in the context of Silicon Valley 27 philanthropy 30, specifically in the context of this article.

Note that many of these tags, for example philanthropy 30, charitable giving 29, Mark Zuckerberg 26, Silicon Valley 27, tech moguls 28 and Mark Zuckerberg tops the list 33 may also easily apply to other articles and other types of content from a variety of sources and in other contexts. To the extent that this is true, tag ranks (and the tag structure and the counting of tag ranks and more presented here) will form a useful and powerful bridge across them, and will create an easy way to serve up related tags dynamically in any context, as well as in the form of dynamic indexes of related content.
A user may—in the context of any element of content she is observing—add any tag she wants and may associate any tag with any other tag. In doing so, she may select tags from automatically-generated pools of related tags (including, or limited to, her own tags added previously to this element of content, or to similar content, or to content). This saves her the need to type in tags twice, or at all, (if another user has already added a tag), greatly improving the efficiency of tagging (both for this user and across users).

FIG. 8 presents another way to express the tags and tag relationships shown in FIG. 7, using a simpler markup that has only root tags and one tier of subordinate tags (although host system supports an unlimited number of tiers).

In FIG. 8, the bolded words (philanthropy 34, Mark Zuckerberg 35, charitable giving 36, Silicon Valley 37, charitable giving by Silicon Valley tech moguls in 2012 38, Mark Zuckerberg tops the list 39, and tech moguls 40) are all root tags. All the rest of the tags shown in FIG. 8 (the tags which are not bolded) are subordinate tags.

The first segment of markup 41 in FIG. 8 is identical to the semantics shown in FIG. 6. (Philanthropy is the root tag. Charitable giving, Mark Zuckerberg, Silicon Valley, and tech moguls are subordinate tags.)

The rest of the markup creates a rough approximation of the more elaborate tag relationships expressed in FIG. 7. The precise equivalency depends on a variety of factors, including which algorithmic weightings are applied to the tag relationships.

Compared to the markup shown in FIG. 7, the markup in FIG. 8 simplifies data entry by a user (especially if handled via a flat interface such as an e-mail, rather than with host's dynamic n-level interfaces). The markup is limited to two levels of tagging (root tags and strings of subordinate tags on those root tags).
Limiting the tag structure to two tiers—root tags and level one subordinate tags makes it easier for a user to perform tagging independent of the host's n-level tagging system. This is useful, for example, when a user is clipping an element of content by e-mailing it to host, with markup placed directly into the body of the e-mail. Such two-tier tags may be used in the context of a complete element of content (in this case a Wall Street Journal article) or may—as appropriate—be applied at the level of one or more highlights of the complete element of content. Other markup formats may be used to achieve identical, or largely similar, results.

By employing the host tagging system, a user may express whatever associations come to mind or pour out of her. She may express her observations in any order. She may use whatever language comes to mind. She faces very few rules or restrictions. She can express herself.

FIG. 9 illustrates how certain types of tag relationships may be assigned point scores, and how these scores make it easy to count cumulative tag association scores. It shows a process for counting the tag association scores in the context of the root and subordinate tags presented in FIG. 6 and also shown in the first segment of markup 41 in FIG. 8.
These ratios are illustrative, and any number may be used.

FIG. 9 has two sections. The first section 42 shows associations between the root tag (philanthropy) and the four subordinate tags (charitable giving, Mark Zuckerberg, Silicon Valley, and tech moguls). These relationships between a root tag and its subordinate tags each get R points.

The second section 43 shows associations between adjacent subordinate tags. Each of these relationships between a subordinate tag and an adjacent observation on the same root tag (as part of the same markup) gets S points. Note that “adjacent” subordinate tags may be presented in a row (using any delimiter) or in a column (as in FIG. 6). Either way, a relationship between any two adjacent subordinate tags gets S points.

The host system counts tag associations (and other content relationships) constantly. Every time something is added or updated or removed, the organic tag relationships and the resulting content indexes change (for individual users, groups of users, sources, authors, and combinations of these and more).

It's like incrementing a numerical counter of each observed relationship, but where each observation has its own tags—the date and time stamp, your location (if available), what you were working on at the time or who you were meeting with (to the extent that the user has made this clear), and other user-added or system-observable information. These and other tags form a dynamic context for each observation (and each observation on each observation, ad infinitum).

Furthermore, any relationship can be numerically weighted in an endless number of ways, as discussed in part below.

The string of text in FIG. 9 (five tags, one root tag and four subordinate tags) creates a network of 10 tag relationships. (If directionality is considered, the network created by these five tags includes 20 relationships.) If a user were to add these five tags as flat tags, then no network would be created (although a tag importance score would be generated).

That is, adding the same number of tags as flat tags, which is indeed always the user's prerogative if she simply adds a list of five root tags, creates much less associational value (the associated tag network) for her own purposes, and much less benefit for other users.

The size of the network of unique relationships (no directionality) that a string of tags creates is

(n²−n)/2

A string of four associated tags creates a 6-relationship tag network. A string of 8 associated tags creates a 28-relationship tag network.

FIG. 10 shows two of many potential point scores for tag associations. In the first example 44, root tag to subordinate tags relationships get two points of association and subordinate tag to subordinate tag relationships get one point of association (R=2, S=1).

In the second example 45, root tag to subordinate tags relationships get 10 points of association and subordinate tag to subordinate tag relationships get one point of association (R=10, S=1).

Of course, these scores extend down to an infinite number of levels of subordinate tags.

For the example shown in FIG. 8, a network of 20 relationships, 15 of which are unique, is created. Thus, much of the network of tag associations for this user (in the context of this article) was created when he added the first string of five tags.

Note that users need not type in all of these tags. As we will show later, the host system makes it easy for the user to reuse tags she has already added to an item of content (or to content in general) and to benefit as well from the tags added by others.

In the host system, an individual user may further curate these relationships, their ordered importance (in general or in any context), and their weightings (again, in general or in any context). However, even if a user never curates or weights a single tag relationship, this organic structure of countable (hence measurable) relationships creates great utility. The host system, which is always counting, can create for this specific user an index of content that treats these tags as related.

The work of this one user benefits all users, even those users who never add a single tag. That is, general indexes of tag associations (relationships) are also able of show these organic relationships (unless the user who added the tags has chosen to conceal them by marking her tags as more private than the host default of anonymous and visible).

The tags make possible organically interoperable indexes of content. Indexes that bridge across content that might otherwise be siloed within technology or philanthropy, for example.

Furthermore, these tags point to whatever content (page, highlight, collection, etc.) the user was tagging when she added the tags.

One implementation of our numerical weighting of tag relationships (the simple counting score) is to give two points of association between a root tag and each of the associated subordinate tags and one point of association between any of the subordinate tags.

In the example shown in FIG. 11, each relationship between the root tag and a subordinate tag earns two points (of tag association score). That is, the relationship between philanthropy and charitable giving 46 is assigned two points. The relationship between philanthropy and Mark Zuckerberg 47 is assigned two points. The relationship between philanthropy and Silicon

Valley 48 is assigned two points. And the relationship between philanthropy and tech moguls 49 is assigned two points.

Each of the relationships between subordinate tags earns one point (of tag association score). That is, in this simplified example the relationship between charitable giving and Mark Zuckerberg 50 is assigned one point. The relationship between charitable giving and Silicon Valley 51 is assigned one point. The relationship between charitable giving and tech moguls 52 is assigned one point. The relationship between Mark Zuckerberg and Silicon Valley 53 is assigned one point. The relationship between Mark Zuckerberg and tech moguls 54 is assigned one point. And the relationship between Silicon Valley and tech moguls 55 is assigned one point.

To allow for dynamic views of associations, other mathematical relationships may also be applied. Useful ratios that may be applied are essentially unlimited. Here are but a few other examples (beyond the two to one ratio described above): one point of association between root tags and subordinate tags and one point of association between subordinate tags and adjacent subordinate tags, b) five points of association between root tags and subordinate tags and one point of association between subordinate tags and adjacent subordinate tags, c) 10 points of association between root tags and subordinate tags and one point of association between subordinate tags and adjacent subordinate tags, d) 100 points of association between root tags and subordinate tags and one point of association between subordinate tags and adjacent subordinate tags.

FIG. 12 shows potential tag association scores and tag importance scores for the tags presented in FIG. 8 based on a two point, one point rule and other assumptions for tag weightings.

More complex calculations of tag importance scores across users, across sources of content, for an author, for a time period, and many others, in almost infinite combination are also possible. For example, root tags on a complete element of content may be assigned a higher tag importance score than root tags on a highlight. In one embodiment, the ratio is two to one. Level one subordinate tags on an element of content (in its entirety) may be assigned one-half point, and level one subordinate tags on content highlights may be assigned one-quarter point. That is, in more powerful computations of tag importance, the presence and the ordering of subordinate tags matters as well.

FIG. 13 shows tag rank algorithm factors.

Note that as a user adds more relationships, her tag importance scores and her tag association scores (collectively tag ranks) may be used to automatically generate indexes of content that bridge across items clipped and across sources and authors and topics and media types and time periods. The more a user adds tags, the more contextual, more granular, and more precise her retrieval of her own saved content becomes. The same is true of her text search or browsing to discover new content (or similar content or content presenting an opposing viewpoint).

Tag ranks make it dramatically easier (compared to an out-and-back structure, as presented in FIG. 1) for an individual user to navigate content.

Note that a user may also choose to navigate her own content (and new content) using any desired blend of her own tag ranks and the tag ranks added by others for the same elements of content. In this case, “her own content” means things she has saved or shared or tagged or curated using the host system. She may also choose such blended views of tag ranks (ranging from general to personal) when navigating content that she has not yet clipped or shared.

She may further choose to limit these views of content to match specific personal or organizational or other mindsets, or to match a topic, or a time period, or any other useful filter, and may do all of this in any desired combination.

Note that—in addition to entire elements of content—this level of differentiation may apply to any highlight, and that the tags associated with highlights of an element of content (such as an article, a photo, a collection of books, etc.) may contribute in a small or moderate or substantial way to the tag count and tag association score for the element of content.

One simple formula for calculating the tag rank of a highlight is:

Tag rank of highlight=A×tag importance score of highlight+B×tag association score of highlight

Where (A) and (B) are weighting factors tied to context (including by not limited to the contextual credibility of the user doing the tagging).

In addition to the attenuation of points for tag importance described above (for example, two points for top-level root tags, one point for highlight root tags, one half point for top-level tags on root tags, and one quarter point for tags on highlight tags), tag importance scores may be further attenuated based on their distance down a list (or across a row), for example by applying a multiplier of 99 percent, or 95 percent, or 90 percent, or any other useful multiplier.

The same sort of attenuation may apply to tag association scores. Any of these associational weightings may be attenuated based on proximity using any potential math for attenuation. For example, whatever the tag association score for the first subordinate tag in a list or row, the score for the second subordinate tag might be 90 percent of this, and the score for the third subordinate tag might be 90 percent of the score for the second, and so on. In the example FIG. 9, and applying the two point, one point rule in FIG. 10, the tag association score for philanthropy and charitable giving would be two points, the tag association score for philanthropy and Mark Zuckerberg would be 1.8 points, the tag association score for philanthropy and Silicon Valley would be 1.62, and the tag association score for philanthropy and tech moguls would be 1.458.

Any percentage or decrement or shifting pattern of percentages or decrements may be applied.

Also, the associational scores for adjacent subordinate tags as shown in the second section 43 of FIG. 9 may be attenuated (or in some unlikely event amplified). For example, in the example above—with a 90 percent attenuation the association score between charitable giving and Mark Zuckerberg would be 1, the association score between charitable giving and Silicon Valley would be 0.9, and the association score between charitable giving and tech moguls would be 0.81. And so on.

Association scores may be further weighted based on the observed credibility of the person doing the tagging.

The algorithmically computed weighting that applies to the tags and tag associations added by a specific user (in general or in a particular context) can be viewed as an amplifier or attenuator on their tags and their tag relationships (in whole or in any part). The weighting may reflect expertise, for example. Or the frequency with which anonymous editorial reviews of the user's tags suggest the that quality and utility to users in general of that user's tags is outstanding, not outrageous (or sloppy, or inaccurate, or poorly worded). Or the results of other methods, algorithmic and human, for separating higher quality, higher utility tags from lower quality, lower utility tags (in general or in a particular context).

This definition is undeniably more contextual, granular, and precise than a simple tag rank. Like the simple tag rank, this definition generates a tag rank that increases as the associations—or contextual associations, or weighted contextual associations, or normalized associations—between the tags (that is, among the indexed elements of content under consideration) increases.

Further amplifiers and attenuators in the present invention may include ratings (and other such variable tags) that a user associates with an element of content. For example, a user may give a content highlight a five-star rating, or she may say (for example, on a scale of negative 10 to positive 10) that she totally loves something. This might have useful implications for how her tags on the element of content are weighted, both for her individual use and for more general usage. Conversely, she might say she totally hates it (leading to a different inference).

Other potential vectors, among many, include important vs trivial, agree vs disagree, I want it vs I have no interest. For example, if the element of content is a pair of shoes, a user might love the shoes overall, but hate the heels. Or love the shoes in every respect, but not be interested in owning them (perhaps they love them as wonderfully designed, but think they are best worn by other people, or that they are wonderful but too expensive).

Matching tags not within a direct string of associations may still be associated, but with attenuation that appropriately reflects the degree of separation on the part of the person adding the tags.

Thus, work by a user (or users) on tagging and on tag associations (observations on observations) will quickly amplify the size of her (or their) network, greatly increasing the contextuality, granularity, and precision of tag matching (and content matching).

It also creates combinatorial math that makes clarity with respect to the structure and weight of tags and tag relationships for a specific user, and for the weighting on a user's tags (in general or in any context, as an indication of utility to other users), absolutely essential.

The beauty of this approach is that streams of counts (and weighted streams of counts, including with different weightings for different users and different contexts) of these contextual point scores for tag importance (tag frequency) and tag associations (tag relationships) can be combined in an almost infinite number of ways.

The host system may include many protections designed to combat the sorts of abuses that always seem to emerge when an Internet service begins to create economic value, among them the familiar problem of tag stuffing. Automated testing may be used to turn off (or crank down the user weightings) for users whose tagging exhibits a pattern of abuse. Users will be able to flag abuses (at the level of individual tags in specific contexts, not at the level of individual users).

One simple technique that is sometimes (but not always) valuable is to normalize the tags on a given clipping, or a clipping by an individual user, to unity. That is, to make the count of tag importance across all of the tags to equal one and to make the tag associations scores add up to one as well. Many other normalization schemes are likely to prove useful.

FIG. 14 shows an example of the utility of tag ranks in adding tags to content. It presents a view of tag options and related tags within a user interface.

The tag options list may include (or disinclude) the titles of the article and the author or authors. In this case, the tag option list includes the future of online advertising 56, banner ads 57, online advertising 58, and the first banner ad 59.

Related tags for online advertising 58 include advertising 60, targeted advertising 61, ad tech 62, banner ads 63, moving beyond banner ads 64, native advertising 65, and the future of online advertising 66.

Related tags that are already included in the list of top level root tags (as listed below my tags 67) are check-marked. The other, unused related tags have a plus sign. By clicking (or touching) the plus sign, a user may pop the tag to the bottom of their list of top level tags (and may then adjust the ordering).

The tag option list is generated using the tag importance score across users for this specific element of content.

The scrollable list of related tags is created using tag association scores across users (as adjusted using a weighting that reflects each individual users contextual heft in creating valuable tags).

To repeat, the tag rank is any weighted combination of the tag importance score and the tag association score. In the cases above, the tag rank for calculating and presenting a useful contextual list of tag options 68 is, in the current implementation, designed to exclude the tag association score (the multiplier for that is zero). The tag rank for calculating and presenting a useful contextual list of related tags 69 is, in the current implementation, designed to exclude the tag importance score (its multiplier is zero).

In other places, (and perhaps even someday for tag options 68 and related tags 69) an even or uneven blend of tag importance scores and tag association scores may prove to be more appropriate.

For both tag importance scores and tag association scores, tag counting may include or exclude duplicate tags. Tag counting may include or exclude tags on highlights. Tag counting may include or exclude tags on tags (including tags on tags on highlights).

There are several other important considerations. Tag counting may include or exclude certain kinds of tags (sources and authors, for example), in order to help the user focus on desired tag choices in a given context.

Weightings on the utility of a user's tags may be specific to a source or publisher, and may even for some of its users be controlled by that publisher for content shown within their host powered user experiences. Weightings may be in general, or specific to a topic or even to a specific element of content.

As just one illustrative example, the tags added by the author of an article may carry considerably more weight (at least in certain circumstances) than the tags added by an experienced user of the host system, and the tags added by an experienced user of the host system may carry considerably more weight than the tags added by an inexperienced user.

The host system may also normalize results for a user or for a group of users or for a source of content or in any other appropriate way. For example, a group of users might include all New York Times subscribers (or all registered users, including free users, or any weighted combination of these two and many more).

FIG. 15 builds on FIG. 14. It shows a user interface in which the user has opened up a second level of related tags 70, in this case on native advertising 71.

FIG. 16 builds on FIG. 14. In this case, it shows the user seeking to add tag details 72 for the top level tag banner ads 73 in the list of my tags 74.

The user may type in a tag, or may select an existing tag that's related to banner ads from the list of related tags 75. In this case, the user has selected the downsides of banner ads 76, which now also shows up in the list above 77 and also in small type 78 next to the top level tag banner ads 73.

FIG. 17 shows that the user may scroll down within related tags 79 to see more tags related to banner ads 80.

FIG. 18 shows the use of tags as a tool for searching. In this case, the user is viewing his tags related to Apple, within the my tags 81 section of the current implementation of the host interface. First, he chose to search on competitive advantage 82. Then he chose to search on Apple 83, which is in the list of related tags for competitive advantage. Then he chose to search on the future of television 84, which is in the list of related tags for Apple. His search parameters also show up at the bottom of this screen, to the left of the search button 85.

FIG. 19 shows a grid of search results for the query posed in FIG. 18. The check marks signify that these are items that the user himself clipped. The user may use refine search 86 to select other tags. Within refine search, visible lists of tags—which represent additional search choices—flow into the interface based on tag ranks (and in some cases the tag ranks of tag options and related tags for the search parameters already selected. This makes it much easier for users to find desired content (whether at the level of whole items of content, or as highlights from across many whole items of content).

In this case, the results are within a specific user's clippings, but the search could be across any group of users. The search results may also be filtered to match any source or author, or any media type (articles, videos, audio, etc.), or any selected time period, or any combinations of these and more.

FIG. 20 shows a full screen view of one of many potential views of content that show up when a user clicks on the search result from The Verge 87 in FIG. 19. In this case, the user sees his highlights for this article (rather than the full text of the article).

FIG. 21 shows an index 88 of this user's tags on these highlights. In this case, just the root level tags appear. In other implementations, the subordinate tags may appear as well. In yet other implementations, the user may have access to a variety of indexes for this article, as created by others (author, editor, publisher, friend) or combinations of these. In yet another, the user may use any of these indexes to search for similar content.
It this case, just root-level highlight tags are shown and they appear in the order of the sequence of user highlights (which, in this case, matching the ordering in the paragraphs in the article itself). The index may also show the deeper tag structure, or a tag cluster for the highlights (based on tag rank). The index may also offer—subject to copyright protection—views of the tags and highlights added by others.

FIG. 22 shows what happens when the user clicks the tag the TV experience needs to be reinvented, too 89. The view of this user's highlights is collapsed and only the content matching this tag appears.

FIG. 23 shows the collapsed highlights that result from checking the tag the TV experience needs to be reinvented, too 89 in FIG. 22. Collapsible content makes reviewing saved highlights much more focused and effective for users. And in certain implementations, the user may choose to share just the selected highlight.

FIG. 24 shows a 6-grid of content. A grid is a kind of index. In this case, it's the user's own clippings, but it could be clippings from any group. The view could be across items shared with the user by the user's network of contacts, or anonymously across all users (subject to privacy controls).

FIG. 25 shows a 1.2-grid of content. Grid sizes and proportions may—in some implementations—be anything the host, or an affiliated publisher, or other organization, or any specify user chooses.

FIG. 26 shows a list view of content. Grids and lists, along with tag options and related tags, are interface building blocks for dynamic content indexes. In this case, the user selects the article from Harvard Business Review 90 to reach the screen in FIG. 27.

FIG. 27 shows the user's highlights from this article. Alternatively, this view may show the text of an article, or the text and photos from an article, or a combination of highlights and photos and tags from the article, and many more. For photos, it may show a photo, or a photo highlight, or a sequence of photo highlights. For video, it may show a video, or a video highlight, or a sequence of video highlights. Or it may show text and video and audio and photos and other content in any desired combination.

FIG. 28 shows a full-screen view of the highlights shown in FIG. 27. Note that a publisher may choose to offer (for free or to subscribers only or for a premium) access to an indexed (highlighted and tagged) version of the entire article, or to multiple indexes for the same content (one by the author, one by the editors, for example). To reach FIG. 28, the user clicks on go to full-screen view 91 in FIG. 27.

FIG. 29 shows an index of the user's highlights, which may be supplemented with publisher and other indexes. It shows an index of the user's tags on his highlights for this article. It shows just the root level tags, but may show any views of tags that are possible with the host system.

FIG. 30 shows the index in FIG. 29 with two tags checked. Or search for other content using the selected tags.

FIG. 31 shows the collapsed view of this user's highlights created by checking the two tags in FIG. 30. By touching the highlights (or by any other appropriate method), the user reaches the view presented in FIG. 32.

FIG. 32 shows a view of the article from FIG. 31 in it's original, unadulterated form. In this example, it's a Web page.

FIG. 33 shows a full screen view of the same Web page as in FIG. 32. In this view, the user has access to host's “bookmarklet functionality” (or to other similar functionality, or to host powered functionality that publishers may integrate into their own Web pages, mobile apps, and other content experiences).

FIG. 34 shows how host's tagging functionality (tag options, related tags), which are sorted based on their tag ranks, may be visible to a user from any Web page, whether a publisher integrates host's services into their own Web pages (or mobile apps) or not.

FIG. 35 shows another view of related tags in the form of a dynamic spiral. Such an interface may also be controlled by voice commands or hand gestures, allowing users to seemingly fly through content choices.

FIG. 36 shows a flow chart of how the host system improves with use. It illustrates one of many potential cycles for tagging, indexing, and personalizing content.

In terms of the benefit to users, the effectiveness of personalization can be improved enormously if the personalization is comprehensive and global (and fully protects the user's privacy). To be effective, such comprehensive personalization must do more than track friends, and “likes” or “pluses” and other social network signals (or real-time or visual social network signals or search engine signals, or advertising system signals, or any combination of these).

To be effective, such personalization would ideally bridge across all of a user's activities, not just browsing (portals) or search or social or advertising. It would bridge across personal and professional interests, activities, and projects. It would bridge across for-profit and charitable work. It would bridge across science, social science, the humanities, the arts, and business, as well as many others. It would bridge across the virtual and the physical. It would bridge across dreaming and doing, considering and buying. That is, it would bridge across every conceivable purpose, interest, or context a user may choose or imagine. And it would bridge each of these and more in ways each user finds satisfying, even delightful.

Equally important, to be effective, an ideal personalization would dovetail with the words a particular user chooses, (that is, tags, or observations, or tags on tags, or observations on observations). Different users often use different words and they use them differently in different contexts. That is, ideal personalization would match a user's preferred language of observations (tags). The words she chooses to use. Not someone else's.

This is not an argument against specialized services. Quite to the contrary. It's an argument that some aspects of the solution to the problem of contextualization and personalization of content (and the protection of privacy) would ideally be integrated across all of the specialties. Indeed that they would ideally be universal and independent and non-competitive. Or that the solution would ideally make such integration radically simpler than is currently the case. And in doing so, that privacy would ideally be protected more deeply (and more broadly and more systematically) than it is possible with today's market-driven and regulatory norms.

Integration is also needed today for the language of tags. Which is to say the language for indexing and tuning and integrating content, for example by topic, and for allowing it to flow—with appropriate compensation—to whomever values it most, across organizational silos and information cul de sacs. Integration of tags across individuals and organizations and sources and authors and information systems might make possible a new kind of customization and personalization of content such that it works wherever you go, and that it protects your privacy wherever you go.

FIG. 37 shows one of many ways a publisher may use host services to personalize views of their own content, and combinations of their own content with content from other sources.

The data for any slider query may be limited to an individual user, or it may combine streams of tag associations across multiple users. It may apply associations to a single tag or to a cluster of tags, to a highlight or to a cluster of highlights, to an entire item of content or to any cluster or other collection of content. It may be calculated for any defined period of time (including with a mathematical decay on or increase of the calculated value of content based on its age).

By adjusting these ratios and weightings, the user may easily see dynamic (rather than static) views of relationships. Each of the related (or associated) tags is a path to related content, and to other indexes and other views of content. Content choices may be presented in the form of a constellation of tags, a constellation of comments, a constellation of highlights or regions of text, audio, video etc., a constellation of whole items of content, and a constellation of curated collections of content (including collections of tags, comments, highlights, and whole items).

Sliders make these indexes of content and presentations of content extraordinarily fluid and dynamic. As a consequence, it may appear to users that they are flying though choices and that they reaching desired results much more quickly (including results they might never have found using current information systems). In one example, such a slider lets a user blend any mix of content between general (what everyone sees, and with not personalization) and personal (matching her preferences, in general or specific to any context).

Other potential sliders include broad vs deep, global vs local, global vs national, Massachusetts vs US, crowd data vs experts, The New York Times vs The Wall Street Journal. Thanks to host's unique data structure, which allows content and tags that were previously siloed to flow together organically, an essentially unlimited number of slider choices are possible.

One analogy is to filters in Photoshop. With organic tagging and tag ranks, users (of all kinds) can view the data many different ways, without needing to do the math themselves.

The items viewed may be filtered to include only your content (collections of content, whole items of content, content highlights, comments, and tags). Or your content plus content from your network of contacts (aka your network, which is to say the people with whom you've shared items of content and tags, or vice versa). Or only content from your network, or content for a particular person in your network. Or only content for a particular author or source or topic. Or any combination of any of the above and many more.

FIG. 38 shows other potential uses of tag ranks.

FIG. 39 shows tag patterns (mindsets) and Fourier analysis, and illustrates the potential for a deeper kind of resonant tuning.

Not all users work together brilliantly. Some people tend to cancel each other out. Productivity droops. Helping users discover and tune to their own natural gifts and find and work effectively with others who energize them seems a worthy cause. The host system has the potential to make this sort of tuning possible. One technique is to use Fourier transforms and other techniques to match patterns (waveforms and others) of tags and tag associations and patterns of tags and mindsets.

Note that in addition to finding content that is similar (“in tune”) it also easy for any user to use host system to find content that is dissimilar (“dissonant”). Access to the best contrary evidence often speeds learning and acknowledgement of contrary evidence (without any requirement that one agree with it) is a hallmark of intellectual curiosity and maturity.

The degree of separation between resonant tags (or tag clusters, or tag patterns, or mindsets) may be determined any number of ways. Typically, tag associations carry the greatest in the specific context within which they were selected (or typed). That is, the tag associations on a highlighted paragraph of an article will carry greater weight than those same tag associations when inferred into other contexts (for the full article, for a collection of similar articles, etc.)

One way of visualizing this is as concentric rings of choices. The further out the ring, the less any potential tag association counts. Another is as waveforms, such as ripples in a pond. Or as the waveforms, and combined waveforms, of musical instruments.

Rings of choices can be a) related tags then tags on related tags then tags on tags, b) potential topics and their tags b) potential authors and their tags c) potential sources and their tags. Or any combination of these and more.

Other implementations are within the scope of the following claims.

1. A method comprising
receiving information representing tags and tag relationships associated by users of content with items of content, and
deriving rankings of items of content based on the tags and tag relationships.

2. The method of claim 1 in which the rankings are based on counts of the tags or the tag relationships or both.

3. The method of claim 2 in which the counts are weighted.

4. The method of claim 1 in which each of at least some of the tags represents an observation by a user with respect to at least one of the items of content.

5. The method of claim 4 in which at least some of the tags represent observations on the observations, recursively.

6. The method of claim 1 in which the rankings are derived based on associations of tags.

7. The method of claim 6 in which the rankings are derived also based on importance of tags.

8. The method of claim 6 in which the associations of tags is inferred based on relationships or normalized relationships of tags.

9. The method of claim 1 in which the rankings are derived by evaluating scores for the tags.

10. The method of claim 1 in which the rankings are determined in part based on context.

11. The method of claim 1 in which a rank of a tag is based on a sum of an importance score of a tag and an association score of a tag.

12. The method of claim 1 comprising using ranks of tags to identify patterns, clusters, or networks of related tags.

13. The method of claim 1 comprising displaying personal preferences of users in context based on the tag rankings.

14. The method of claim 1 comprising displaying preferences of groups of users in context based on the tag rankings.

15. The method of claim 1 comprising displaying to a user tags and rankings of tags in context.

16. The method of claim 1 comprising using the tag rankings in creating, organizing, or distributing items of content to users.

17. The method of claim 1 comprising forming dynamic indexes of tags for users.

18. A method comprising
ranking items of content based on information about tags provided by users of the items content.

19. The method of claim 18 in which the items are ranked contextually.

20. A method comprising
evaluating associations among items of content using observations and observations on observations provided by one or more users of the items of content, and in a specific context.
